(19) United States
(12) Patent Application Publication
(10) Pub. No.: US 2026/0039127 A1
(43) Pub. Date: Feb. 5, 2026

(54) OVERCURRENT PROTECTION SYSTEM

(71) Applicant: JAGUAR LAND ROVER LIMITED, Coventry (GB)

(72) Inventor: Pratik AGARWAL, Coventry (GB)

(21) Appl. No.: 18/793,475

(22) Filed: Aug. 2, 2024

(51) Int. Cl. H02J 7/00; B60L 58/10; H01M 50/569

(52) U.S. Cl. CPC H02J 7/00304; B60L 58/10; H01M 50/569; B60L 2210/10; B60L 2210/40; H02J 2207/20

(57) ABSTRACT

The present disclosure relates to an overcurrent protection system for a vehicle whereby an electrochemical cell provides an interface between an inverter and a DC-DC converter. One or more sensors are operatively connected a terminal of an electrochemical cell for determining a current therethrough, and a switch is operated to enter a second state whereby a conductive path through an electrical terminal of the electrochemical cell is interrupted in dependence on a measured current. The present disclosure also relates to a vehicle.

### TECHNICAL FIELD

The present disclosure relates to an overcurrent protection system. More specifically, the present disclosure relates to an overcurrent protection system for a vehicle, and in particular a mild hybrid electric vehicle. Aspects of the invention relate to an overcurrent protection system and a to a vehicle.

### BACKGROUND

Mild hybrid electric vehicles (MHEV) combine a traditional internal combustion engine powertrain system with an on-board battery, generator and motor system. MHEVs may provide power assist to the internal combustion engine, but cannot be driven in an electric-only mode. The on-board battery is used to power components that would normally rely on the internal combustion engine.

Conventionally, circuit protection is provided by one or more fuses configured to break a circuit in order to prevent short circuit damage. In the case of MHEVs, the on-board battery may form part of a 48 volt system, and new vehicle developments place large current demands on fuse box connectors and busbars. Therefore, it would be advantageous to provide an alternative means of circuit protection.

### SUMMARY OF THE INVENTION

It is an aim of the present invention to address one or more of the disadvantages associated with the prior art.

A broad aspect relates to an overcurrent protection system for a vehicle, the system comprising: a processor; one or more sensors operatively connected to the processor; and an electrochemical cell comprising: a first electrical terminal and a second electrical terminal having a conductive path defined therebetween; a switch having a first state in which a conductive path through the first electrical terminal is uninterrupted, and second state in which a conductive path through the first electrical terminal is interrupted; wherein the one or more sensors is or are operatively connected to the first electrical terminal and/or the second electrical terminal of the electrochemical cell for determining a current therethrough; and wherein the processor is configured to: receive one or more signals representative of a measured current at the first electrical terminal and/or the second electrical terminal of the electrochemical cell, in use; and cause the switch to enter the second state in dependence on the measured current.

A broad aspect relates to a vehicle, e.g. a mild hybrid electric vehicle, overcurrent protection system, the system comprising: a processor; one or more sensors operatively connected to the processor; and an electrochemical cell comprising: a first electrical terminal and a second electrical terminal having a conductive path defined therebetween; a switch having a first state in which a conductive path through the first electrical terminal is uninterrupted, and second state in which a conductive path through the first electrical terminal is interrupted; wherein the one or more sensors is or are operatively connected to the first electrical terminal and/or the second electrical terminal of the electrochemical cell for determining a current therethrough; and wherein the processor is configured to: receive one or more signals representative of a measured current at the first electrical terminal and/or the second electrical terminal of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a first electrical terminal having a plurality of electrical contacts and a second electrical terminal having plurality of electrical contacts, and a conductive path defined between the first electrical terminal and the second electrical terminal; a switch having a first state in which a conductive path through the first electrical terminal is uninterrupted, and second state in which a conductive path through the first electrical terminal is interrupted; wherein the one or more sensors is or are operatively connected to the first electrical terminal and/or the second electrical terminal of the electrochemical cell for determining a current therethrough; and wherein the processor is configured to: receive one or more signals representative of a measured current at the first electrical terminal and/or the second electrical terminal of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a first electrical contact and a second electrical contact having a conductive path defined therebetween; a switch having a first state in which a conductive path through the first electrical contact is uninterrupted, and second state in which a conductive path through the first electrical contact is interrupted; wherein the one or more sensors is or are operatively connected to the first electrical contact and/or the second electrical contact of the electrochemical cell for determining a current therethrough; and wherein the processor is configured to: receive one or more signals representative of a measured current at the first electrical contact and/or the second electrical contact of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a positive electrical terminal and a negative electrical terminal having a conductive path defined therebetween; a switch having a first state in which a conductive path through the positive electrical terminal is uninterrupted, and second state in which a conductive path through the positive electrical terminal is interrupted; wherein the one or more sensors is or are operatively connected to the positive electrical terminal and/or the negative electrical terminal of the electrochemical cell for determining a current therethrough; and wherein the processor is configured to: receive one or more signals representative of a measured current at the positive electrical terminal and/or the negative electrical terminal of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a positive electrical terminal and a negative electrical terminal; a switch having a first state in which a conductive path through the positive electrical terminal is uninterrupted, and second state in which a conductive path through the positive electrical terminal is interrupted; wherein the one or more sensors is or are operatively connected to the positive electrical terminal and/or the negative electrical terminal of the electrochemical cell for determining a current therethrough; and wherein the processor is configured to: receive one or more signals representative of a measured current at the positive electrical terminal and/or the negative electrical terminal of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a positive electrical terminal having a busbar and a negative electrical terminal having a busbar, a conductive path defined between the positive electrical terminal and the second electrical terminal; a switch having a first state in which a conductive path through the positive electrical terminal is uninterrupted, and second state in which a conductive path through the positive electrical terminal is interrupted; wherein the one or more sensors is or are operatively connected to the positive electrical terminal and/or the negative electrical terminal of the electrochemical cell for determining a current therethrough; and wherein the processor is configured to: receive one or more signals representative of a measured current at the positive electrical terminal and/or the negative electrical terminal of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a positive electrical terminal having a plurality of electrical contacts and a negative electrical terminal having a plurality of electrical contacts, a conductive path defined between the positive electrical terminal and the negative electrical terminal; a switch having a first state in which a conductive path through the positive electrical terminal is uninterrupted, and second state in which a conductive path through the positive electrical terminal is interrupted; wherein the one or more sensors is or are operatively connected to the positive electrical terminal and/or the negative electrical terminal of the electrochemical cell for determining a current therethrough; and wherein the processor is configured to: receive one or more signals representative of a measured current at the positive electrical terminal and/or the negative electrical terminal of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a positive electrical terminal having a busbar comprising plurality of electrical contacts and a negative electrical terminal having a busbar having a plurality of electrical contacts, a conductive path defined between the positive electrical terminal and the negative electrical terminal; a switch having a first state in which a conductive path through the positive electrical terminal is uninterrupted, and second state in which a conductive path through the positive electrical terminal is interrupted; wherein the one or more sensors is or are operatively connected to the positive electrical terminal and/or the negative electrical terminal of the electrochemical cell for determining a current therethrough; and wherein the processor is configured to: receive one or more signals representative of a measured current at the positive electrical terminal and/or the negative electrical terminal of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: an input and an output having a conductive path defined therebetween; a switch having a first state in which the conductive path is uninterrupted, and second state in which the conductive path is interrupted; wherein the one or more sensors is or are operatively connected to the input and/or the output of the electrochemical cell for determining a current therethrough; and wherein the processor is configured to: receive one or more signals representative of a measured current at the input and/or the output of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: an input and an output; a switch having a first state in which a conductive path through the output is uninterrupted, and second state in which a conductive path through the output is interrupted; wherein the one or more sensors is or are operatively connected to the input and/or the output of the electrochemical cell for determining a current therethrough; and wherein the processor is configured to: receive one or more signals representative of a measured current at the input and/or the output of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a first electrical terminal and a second electrical terminal, the first electrical terminal being a current output, and the second electrical terminal being a current input, when the electrochemical cell is in a charging condition; a switch having a first state in which a conductive path through the first electrical terminal is uninterrupted, and second state in which a conductive path through the first electrical terminal is interrupted; wherein the one or more sensors is or are operatively connected to the first electrical terminal and/or the second electrical terminal of the electrochemical cell for determining a current therethrough; and wherein the processor is configured to: receive one or more signals representative of a measured current at the first electrical terminal and/or the second electrical terminal of the electrochemical cell, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a first electrical terminal and a second electrical terminal, the first electrical terminal having a current output and the second electrical terminal having a current input, when the electrochemical cell is in a charging condition; a switch having a first state in which a conductive path through the first electrical terminal is uninterrupted, and second state in which a conductive path through the first electrical terminal is interrupted; the system further comprising: an electrical conductor electrically connected to the first electrical terminal and/or the second electrical terminal of the electrochemical cell; wherein the one or more sensors is or are operatively connected to the electrical conductor for determining a current passing therealong; wherein the processor is configured to: receive one or more signals representative of measured current passing along the electrical conductor, in use; and cause the switch to enter the second state in dependence on the measured current.

A broad aspect relates to a mild hybrid electric vehicle overcurrent protection system, the system comprising: a processor; one or more sensors operatively connected to the processor; and an electrochemical cell comprising: a first electrical terminal and a second electrical terminal, the first electrical terminal having a current output and the second electrical terminal having a current input, when the electrochemical cell is in a charging condition; a switch having a first state in which a conductive path through the first electrical terminal is uninterrupted, and second state in which a conductive path through the first electrical terminal is interrupted; the system further comprising: an electrical conductor electrically connected to the first electrical terminal and/or the second electrical terminal of the electrochemical cell; wherein the one or more sensors is or are operatively connected to the electrical conductor for determining a current passing therealong; wherein the processor is configured to: receive one or more signals representative of measured current passing along the electrical conductor, in use; and cause the switch to enter the second state in dependence on the measured current.

A broad aspect relates to an overcurrent protection system for a vehicle, the system comprising: a processor; one or more sensors operatively connected to the processor; and an electrochemical cell comprising: a first electrical contact and a second electrical contact, the first electrical contact having a current output and the second electrical contact having a current input, when the electrochemical cell is in a charging condition; a switch having a first state in which a conductive path through the first electrical contact is uninterrupted, and second state in which a conductive path through the first electrical contact is interrupted; the system further comprising: an electrical conductor electrically connected to the first electrical contact and/or the second electrical contact of the electrochemical cell; wherein the one or more sensors is or are operatively connected to the electrical conductor for determining a current passing therealong; wherein the processor is configured to: receive one or more signals representative of measured current passing along the electrical conductor, in use; and cause the switch to enter the second state in dependence on the measured current.

A broad aspect relates to an overcurrent protection system for a vehicle, the system comprising: a power electronics module comprising: an electrochemical cell having a first electrical terminal and a second electrical terminal; an inverter electrically connected to the first electrical terminal of the electrochemical cell; a DC-DC converter electrically connected to the first electrical terminal of the electrochemical cell: wherein the electrochemical cell further comprises a switch having a first state in which a conductive path through the first electrical terminal is uninterrupted and electrical communication is provided between the inverter and the DC-DC converter, and second state in which a conductive path through the first electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the first electrical terminal and/or the second electrical terminal of the electrochemical cell, in use, and cause the switch to enter the second state in dependence on the measured current.

A broad aspect relates to a mild hybrid electric vehicle overcurrent protection system, the system comprising: a power electronics module comprising: an electrochemical cell having a first electrical terminal and a second electrical terminal; an inverter electrically connected to the first electrical terminal of the electrochemical cell; a DC-DC converter electrically connected to the first electrical terminal of the electrochemical cell: wherein the electrochemical cell further comprises a switch having a first state in which a conductive path through the first electrical terminal is uninterrupted and electrical communication is provided between the inverter and the DC-DC converter, and second state in which a conductive path through the first electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the first electrical terminal and/or the second electrical terminal of the electrochemical cell, in use, and cause the switch to enter the second state in dependence on the measured current.

A broad aspect relates to an overcurrent protection system for a vehicle, the system comprising: a power electronics module comprising: an electrochemical cell having a first electrical terminal and a second electrical terminal and a conductive path defined therebetween; an inverter electrically connected to the first electrical terminal of the electrochemical cell; a DC-DC converter electrically connected to the first electrical terminal of the electrochemical cell: wherein the electrochemical cell further comprises a switch having a first state in which a conductive path through the first electrical terminal is uninterrupted and electrical communication is provided between the inverter and the DC-DC converter, and second state in which a conductive path through the first electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the first electrical terminal and/or the second electrical terminal of the electrochemical cell, in use, and cause the switch to enter the second state in dependence on the measured current.

A broad aspect relates to an overcurrent protection system for a vehicle, the system comprising: a power electronics module comprising: an electrochemical cell having a first electrical terminal and a second electrical terminal and a conductive path defined therebetween; an inverter electrically connected to the first electrical terminal of the electrochemical cell; a DC-DC converter electrically connected to the first electrical terminal of the electrochemical cell: wherein the electrochemical cell further comprises a switch between the first electrical terminal and the second electrical terminal and having a first state in which a conductive path through the first electrical terminal is uninterrupted and electrical communication is provided between the inverter and the DC-DC converter, and second state in which a conductive path through the first electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the first electrical terminal and/or the second electrical terminal of the electrochemical cell, in use, and cause the switch to enter the second state in dependence on the measured current.

A broad aspect relates to an overcurrent protection system for a vehicle, the system comprising: a power electronics module comprising: an electrochemical cell having a first electrical terminal and a second electrical terminal; an inverter electrically connected to the first electrical terminal of the electrochemical cell; a DC-DC converter electrically connected to the first electrical terminal of the electrochemical cell: wherein the electrochemical cell further comprises a switch having a first state in which a conductive path through the first electrical terminal is uninterrupted and electrical communication is provided between the inverter and the DC-DC converter, and second state in which a conductive path through the first electrical terminal is interrupted and no electrical communication is provided between the inverter and the DC-DC converter.

A broad aspect relates to an overcurrent protection system for a vehicle, the system comprising: a power electronics module comprising: an electrochemical cell having a first electrical terminal and a second electrical terminal; an inverter electrically connected to the first electrical terminal of the electrochemical cell; a DC-DC converter electrically connected to the second electrical terminal of the electrochemical cell: wherein the electrochemical cell further comprises a switch having a first state in which a conductive path through the first electrical terminal is uninterrupted and second state in which a conductive path through the first electrical terminal is interrupted; the system further comprising: a processor; one or more sensors operatively connected to the processor; wherein the processor is configured to: receive one or more signals representative of a measured current at the first electrical terminal and/or the second electrical terminal of the electrochemical cell, in use, and cause the switch to enter the second state in dependence on the measured current.

A broad aspect relates to an overcurrent protection system for a vehicle, the system comprising: a power electronics module comprising: an electrochemical cell having a first electrical terminal having a plurality of electrical contacts and a second electrical terminal having a plurality of electrical contacts; an inverter electrically connected to a contact of the first electrical terminal of the electrochemical cell; a DC-DC converter electrically connected to another contact of the first electrical terminal of the electrochemical cell: wherein the electrochemical cell further comprises a switch having a first state in which a conductive path through the first electrical terminal is uninterrupted and electrical communication is provided between the inverter and the DC-DC converter, and second state in which a conductive path through the first electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the first electrical terminal and/or the second electrical terminal of the electrochemical cell, in use, and cause the switch to enter the second state in dependence on the measured current.

A broad aspect relates to an overcurrent protection system for a vehicle, the system comprising: a power electronics module comprising: an electrochemical cell having a first electrical contact and a second electrical contact; an inverter electrically connected to the first electrical contact of the electrochemical cell; a DC-DC converter electrically connected to the second electrical contact of the electrochemical cell: wherein the electrochemical cell further comprises a switch having a first state in which a conductive path through the first electrical contact is uninterrupted and electrical communication is provided between the inverter and the DC-DC converter, and second state in which a conductive path through the first electrical contact is interrupted and no electrical communication is provided between the inverter and the DC-DC converter; the system further comprising: a processor; one or more sensors operatively connected to the processor; wherein the processor is configured to: receive one or more signals representative of a measured current at the first electrical contact and/or the second electrical contact of the electrochemical cell, in use, and cause switch to enter the second state in dependence on the measured current.

A broad aspect relates to an overcurrent protection system for a vehicle, the system comprising: a power electronics module comprising: an electrochemical cell having a positive electrical terminal and a negative electrical terminal; an inverter electrically connected to the positive electrical terminal of the electrochemical cell; a DC-DC converter electrically connected to the positive electrical terminal of the electrochemical cell: wherein the electrochemical cell further comprises a switch having a first state in which a conductive path through the positive electrical terminal is uninterrupted and electrical communication is provided between the inverter and the DC-DC converter, and second state in which a conductive path through the positive electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the positive electrical terminal and/or the negative electrical terminal of the electrochemical cell, in use, and cause switch to enter the second state in dependence on the measured current.

A broad aspect relates to an overcurrent protection system for a vehicle, the system comprising: a power electronics module comprising: an electrochemical cell having a positive electrical terminal and a negative electrical terminal and a conductive path therebetween; an inverter electrically connected to the positive electrical terminal of the electrochemical cell; a DC-DC converter electrically connected to the positive electrical terminal of the electrochemical cell: wherein the electrochemical cell further comprises a switch having a first state in which a conductive path through the positive electrical terminal is uninterrupted and electrical communication is provided between the inverter and the DC-DC converter, and second state in which a conductive path through the positive electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the positive electrical terminal and/or the negative electrical terminal of the electrochemical cell, in use, and cause switch to enter the second state in dependence on the measured current.

A broad aspect relates to an overcurrent protection system for a vehicle, the system comprising: a power electronics module comprising: an electrochemical cell having a positive electrical terminal and a negative electrical terminal and a conductive path therebetween; an inverter electrically connected to the positive electrical terminal of the electrochemical cell; a DC-DC converter electrically connected to the positive electrical terminal of the electrochemical cell: wherein the electrochemical cell further comprises a switch between the positive electrical terminal and the negative electrical terminal and having a first state in which a conductive path through the positive electrical terminal is uninterrupted and electrical communication is provided between the inverter and the DC-DC converter, and second state in which a conductive path through the positive electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the positive electrical terminal and/or the negative electrical terminal of the electrochemical cell, in use, and cause switch to enter the second state in dependence on the measured current.

A broad aspect relates to an overcurrent protection system for a vehicle, the system comprising: a power electronics module comprising: an electrochemical cell having a positive electrical terminal having a busbar and a negative electrical terminal having a busbar; an inverter electrically connected to the busbar of the positive electrical terminal; a DC-DC converter electrically connected to the busbar of the positive electrical terminal; wherein the electrochemical cell further comprises a switch having a first state in which a conductive path through the positive electrical terminal is uninterrupted and electrical communication is provided between the inverter and the DC-DC converter, and second state in which a conductive path through the positive electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the positive electrical terminal and/or the negative electrical terminal of the electrochemical cell, in use, and cause switch to enter the second state in dependence on the measured current.

A broad aspect relates to an overcurrent protection system for a vehicle, the system comprising: a power electronics module comprising: an electrochemical cell having a positive electrical terminal having a busbar comprising a plurality of electrical contacts and a negative electrical terminal having a busbar comprising a plurality of electrical contacts; an inverter electrically connected to a contact of the busbar of the positive electrical terminal; a DC-DC converter electrically connected to another contact of the busbar of the positive electrical terminal; wherein the electrochemical cell further comprises a switch having a first state in which a conductive path through the positive electrical terminal is uninterrupted and electrical communication is provided between the inverter and the DC-DC converter, and second state in which a conductive path through the positive electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the positive electrical terminal and/or the negative electrical terminal of the electrochemical cell, in use, and cause switch to enter the second state in dependence on the measured current.

A broad aspect relates to an overcurrent protection system for a vehicle, the system comprising: a power electronics module comprising: an electrochemical cell having an input and an output; an inverter electrically connected to the input of the electrochemical cell; a DC-DC converter electrically connected to the output of the electrochemical cell: wherein the electrochemical cell further comprises a switch having a first state in which a conductive path through the output is uninterrupted and electrical communication is provided between the inverter and the DC-DC converter, and second state in which a conductive path through the output is interrupted and no electrical communication is provided between the inverter and the DC-DC converter; the system further comprising: a processor; one or more sensors operatively connected to the processor; wherein the processor is configured to: receive one or more signals representative of a measured current at the input and/or the output of the electrochemical cell, in use, and cause the switch to enter the second state in dependence on the measured current.

A broad aspect relates to an overcurrent protection system for a vehicle, the system comprising: a power electronics module comprising: an electrochemical cell having a first electrical terminal and a second electrical terminal; an inverter electrically connected to each of the first electrical terminal and the second electrical terminal of the electrochemical cell; a DC-DC converter electrically connected to the first electrical terminal of the electrochemical cell: wherein the electrochemical cell further comprises a switch having a first state in which a conductive path through the first electrical terminal is uninterrupted and electrical communication is provided between the inverter and the DC-DC converter, and second state in which a conductive path through the first electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the first electrical terminal and/or the second electrical terminal of the electrochemical cell, in use, and cause the switch to enter the second state in dependence on the measured current.

A broad aspect relates to an overcurrent protection system for a vehicle, the system comprising: a power electronics module comprising: an electrochemical cell having a positive electrical terminal and a negative electrical terminal; an inverter electrically connected to each of the positive electrical terminal and the negative electrical terminal; a DC-DC converter electrically connected to the positive electrical terminal of the electrochemical cell: wherein the electrochemical cell further comprises a switch having a first state in which a conductive path through the positive electrical terminal is uninterrupted and electrical communication is provided between the inverter and the DC-DC converter, and second state in which a conductive path through the positive electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the positive electrical terminal and/or the negative electrical terminal of the electrochemical cell, in use, and cause switch to enter the second state in dependence on the measured current.

A broad aspect relates to an overcurrent protection system for a vehicle, the system comprising: a power electronics module comprising: an electrochemical cell having a positive electrical terminal having a busbar comprising a plurality of electrical contacts and a negative electrical terminal having a busbar comprising a plurality of electrical contacts; an inverter electrically connected to a contact of the busbar of the positive electrical terminal and connected to a contact of the busbar of the negative electrical terminal; a DC-DC converter electrically connected to another contact of the busbar of the positive electrical terminal; wherein the electrochemical cell further comprises a switch having a first state in which a conductive path through the positive electrical terminal is uninterrupted and electrical communication is provided between the inverter and the DC-DC converter, and second state in which a conductive path through the positive electrical terminal is interrupted and no electrical communication is provided between the inverter and the DC-DC converter; the system further comprising: a processor; one or more sensors operatively connected to the processor; wherein the processor is configured to: receive one or more signals representative of a measured current at the positive electrical terminal and/or the negative electrical terminal of the electrochemical cell, in use, and cause switch to enter the second state in dependence on the measured current.

A broad aspect relates to a vehicle comprising the overcurrent protection system or mild hybrid electric vehicle overcurrent protection system described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic of an overcurrent protection system according to an embodiment of the invention;

FIG. 2 shows a simplified schematic of the overcurrent protection system of FIG. 1;

FIG. 3 shows a plan view of part of an overcurrent protection system according to an embodiment of the invention;

FIG. 4 shows a perspective view of the system of FIG. 3; and

FIG. 5 shows a vehicle in accordance with an embodiment of the invention.

### DETAILED DESCRIPTION

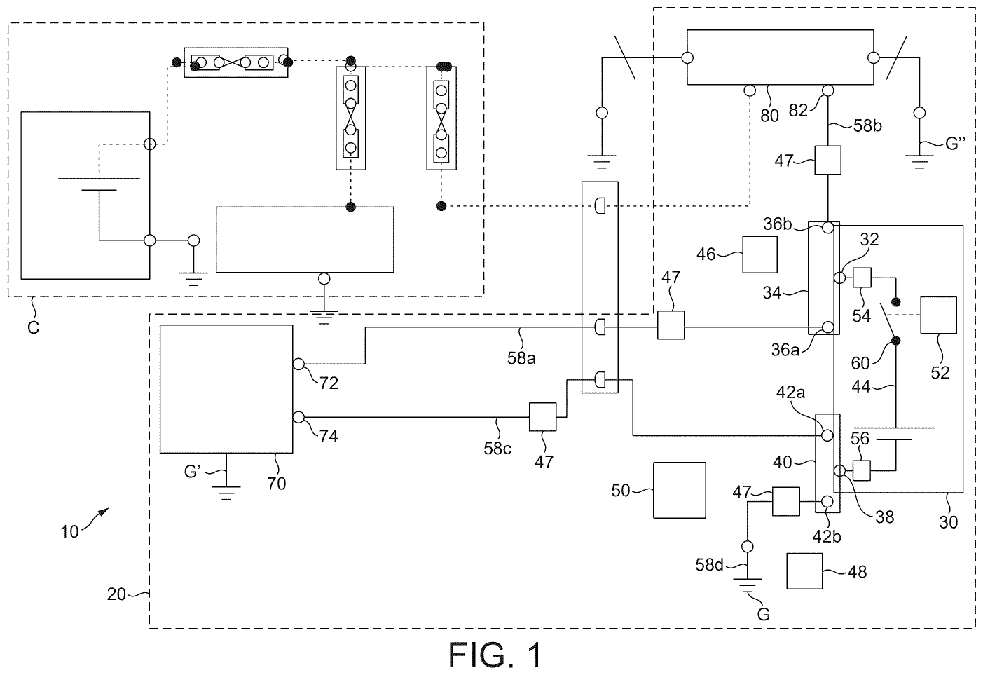

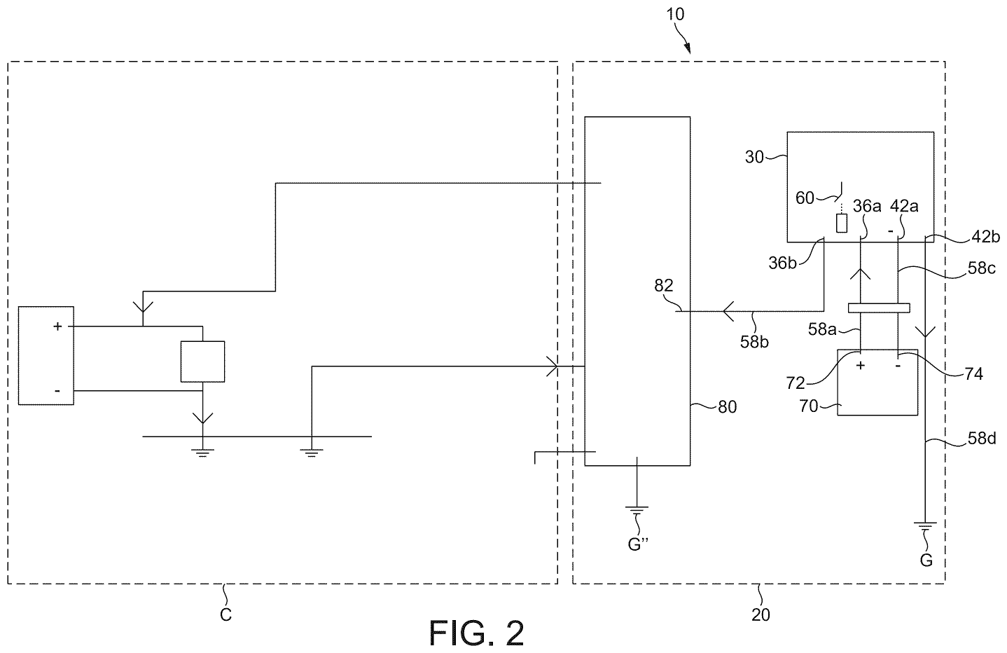

An overcurrent protection system for a vehicle or a vehicle overcurrent protection system (hereinafter “overcurrent protection system”) 10 in accordance with an embodiment of the invention is described herein with reference to accompanying FIGS. 1 and 2. The overcurrent protection system 10 may be incorporated into a mild hybrid electric vehicle (MHEV), or an electrical system thereof. The overcurrent protection system 10 may be for or incorporated into a mild hybrid electric vehicle architecture. The overcurrent protection system may provide or manage circuit protection.

The overcurrent protection system 10 may include a power electronics module 20 which may form part of a 48 volt circuit. The power electronics module 20 may be a 48 volt electrical module. The power electronics module 20 may be devoid of an external overcurrent protection device, e.g. a fuse, and may include an electrochemical cell or battery (hereinafter electrochemical cell) 30, an inverter 70 and a DC-DC converter 80. The DC-DC converter 80 may be arranged to reduce the voltage from 48 volts to 12 volts for powering ancillary components within a 12 volt circuit C. The primary focus of this detailed description will be the power electronics module 20 and 48 volt circuit.

As will be described in greater detail below, each of the inverter 70 and DC-DC converter 80 may be connected to a terminal of the electrochemical cell 30. In the present embodiment, the electrochemical cell 30 may provide an interface between the inverter 70 and the DC-DC converter 80, and may include a switch 60. The switch 60 may have a first state in which electrical communication is permitted between the inverter 70 and DC-DC converter 80 via the electrochemical cell 30 and a second state in which no electrical communication is permitted between the inverter 70 and DC-DC converter 80. In use, the operational state of the switch 60 may be controlled in dependence on a measured current at one or more terminals of the electrochemical cell 30. As such, in the event of a fault or short circuit within the power electronics module 20, the electrochemical cell 30 may be used to break the circuit between the inverter 70 and DC-DC converter 80 so as to protect components from short circuit damage. This provides an alternative means of breaking a circuit to the use of one or more fuses.

The electrochemical cell 30 may be a lithium-ion battery or any other suitable electrochemical cell and may have an electrical potential of 48 volts. The electrochemical cell 30 may have a first electrical terminal or first electrical contact (hereinafter first electrical terminal) 32 which may be a positive electrical terminal in this embodiment. The first electrical terminal 32 may have or be electrically connected to a busbar 34 having a plurality of electrical contacts 36a, 36b. The busbar 34 shown in FIG. 1 has two electrical contacts 36, 36b, but it will be appreciated that any other suitable number of electrical contacts may be provided.

The electrochemical cell 30 may also have a second electrical terminal or second electrical contact (hereinafter second electrical terminal) 38 which may be a negative electrical terminal or ground terminal in this embodiment. The second electrical terminal 38 may have or be electrically connected to a busbar 40 having a plurality of electrical contacts 42a, 42b. The busbar 40 shown in FIG. 1 has two electrical contacts 42a, 42b, but it will be appreciated that any other suitable number of electrical contacts may be provided.

A conductive path 44 may be provided between the first and second electrical terminals 32, 38 and the switch 60 may be provided on the conductive path 44. The switch 60 may be a relay or a solid state switch in this embodiment and may have first state or closed state (hereinafter “first state”, not shown) in which the conductive path 44 between the first and second electrical terminals 32, 38 is uninterrupted. The switch 60 may also have a second state or open state (hereinafter “second state”), as shown in FIGS. 1 and 2, in which the conductive path 44 between the first and second electrical terminals 32, 38 is interrupted. In the first state a conductive path through the first electrical terminal 32 may be uninterrupted. In the second state a conductive path through the first electrical terminal 32 may be interrupted. Although the switch 60 is described as being a relay or solid state switch, it will be appreciated that any other suitable switch may be provided.

The power electronics module 10 or electrochemical cell 30 may include a sensor 46 operatively connected to the first electrical terminal 32 and a further sensor 48 operatively connected to the second electrical terminal 38. The sensors 46, 48 may be arranged to determine a current passing through their respective terminal. More specifically, the sensor 46 may be configured to determine the current received at the electrochemical cell 30 from the inverter 70 and/or the current drawn from the electrochemical cell 30 by the DC-DC converter 80. The sensor 48 may be configured to determine the current drawn from the electrochemical cell 30 by the inverter 70. It will be appreciated that instead of having two sensors 46, 48, there may instead be a single sensor operatively connected to each of the first electrical terminal 32 and the second electrical terminal 38.

The power electronics module 10 or electrochemical cell 30 may also include a processor 50 which may be operatively connected with one or each of the sensors 46, 48 and configured to receive one or more signals representative of a measured current at the first electrical terminal 32 and/or the second electrical terminal 38. The processor 50 may also be operatively connected with the switch 60, e.g. directly or via a controller 52, and may be configured to cause the switch 60 to move between the first state and the second state in dependence on the measured current. The controller 52 may be a battery energy control module (BECM).

The processor 50 may be operatively connected to the inverter 70 and may be configured to receive one or more signals representative of a current sent from the inverter 70 to the electrochemical cell 30. It will also be appreciated that the processor 50 may be operatively connected to the DC-DC converter 80 and may be configured to receive one or more signals representative of a current drawn from the electrochemical cell 30 by the DC-DC converter 80.

A field effect transistor 54 may be operatively connected to the first electrical terminal 32. The field effect transistor 54 may be operatively connected to the controller 52. The processor 50 may be configured to send a command signal to the controller 52 to cause an input voltage to be provided to the field effect transistor 54 if it is determined that the switch 60 fails to enter the second state. A further field effect transistor 56 may be operatively connected to the second electrical terminal 38. The field effect transistor 56 may be operatively connected to the controller 52. The processor 50 may be configured to send a command signal to the controller 52 to cause an input voltage to be provided to the field effect transistor 56 if it is determined that the switch 60 fails to enter the second state.

It will be appreciated that the field effect transistors 54, 56 need not be operatively connected to the controller 52, but instead may be operatively connected to a different controller and/or each may have their own respective controller

A first contact 36a of the first electrical terminal 32 may be electrically connected to a positive terminal 72 of the inverter 70 by a first electrical conductor, cable or wire (hereinafter electrical conductor) 58a. A second contact 36b of the first electrical terminal 32 may be electrically connected to a positive terminal 82 of the DC-DC converter 80 by a second electrical conductor 58b. It will be appreciated that a field effect transistor may be operatively connected to the positive terminal 82 of the DC-DC converter 80.

A first contact 42a of the second electrical terminal 38 may be electrically connected to a negative terminal 74 of the inverter 70 by a third electrical conductor, cable or wire (hereinafter electrical conductor) 58c. A second contact 42b of the second electrical terminal 38 may be electrically connected to a ground point or ground terminal G by a fourth electrical conductor 58d. The inverter 70 may also be electrically connected to a ground point or ground terminal (hereinafter “ground terminal”) G′. Furthermore, the DC-DC converter 80 may also be electrically connected to a ground point or ground terminal G″.

In use, when the electrochemical cell 30 is being charged current may flow from the inverter 70 along the first electrical conductor 58a and into the electrochemical cell 30 via the first contact 36a. Furthermore, when the electrochemical cell 30 is supplying power to the 12 volt circuit via the DC-DC converter 80, current may flow from the electrochemical cell 30, through the second contact 36b, and along the second electrical conductor 58b and into the DC-DC converter 80 via the positive terminal 82. It will be appreciated that one or more of the conductors 58a;58d may include a respective sensor 47 operatively connected therewith and arranged to determine a current passing therethrough. One or each sensor 47 may be operatively connected with the processor 50 and configured to send one or more signals representative of a measured current passing along the electrical conductor, in use.

When the switch 60 is in the first state, a first closed-loop electrical circuit may be provided by the first electrical conductor 58a and the third electrical conductor 58c. A further closed-loop electrical circuit may be provided by the first electrical conductor 58a, the ground terminal G and ground terminal G′. An even further closed-loop electrical circuit may be provided by the second electrical conductor 58b, the ground terminal G and the ground terminal G″. When the switch 60 is in the second state, none of these closed-loop electrical circuits may be complete, and no current may be permitted to flow from the inverter 70 to the electrochemical cell 30 or from the electrochemical cell 30 to the DC-DC converter 80. Alternatively, when either of the field effect transistors 54, 56 have a current supplied thereto, none of the aforementioned closed-loop circuits may be complete.

In use, the processor 50 may be configured to compare the current measured by one or more of the sensors 46, 47, 48 with a predetermined current threshold. The predetermined current threshold may be stored in a memory. If it is determined that the measured current is greater than a predetermined current threshold, the processor 50 may send a command signal directly to the switch 60, e.g. or to the switch 60 via the controller 52, to cause the switch 60 enter the second state. In the event that the switch 60 fails to enter the second state, the processor 50 may be configured to send a command signal to the controller 52 to cause an input voltage to be provided to the field effect transistor 54 and/or 56.

The processor 50 may send a command signal directly to the switch 60, or to the switch 60 via the controller 52, to cause the switch 60 enter the second state if it is determined that the measured current is greater than a predetermined current threshold. The predetermined current threshold may be 60 Amps and the predetermined time period may be less than or equal to 10 seconds, for example less than or equal to 5 seconds.

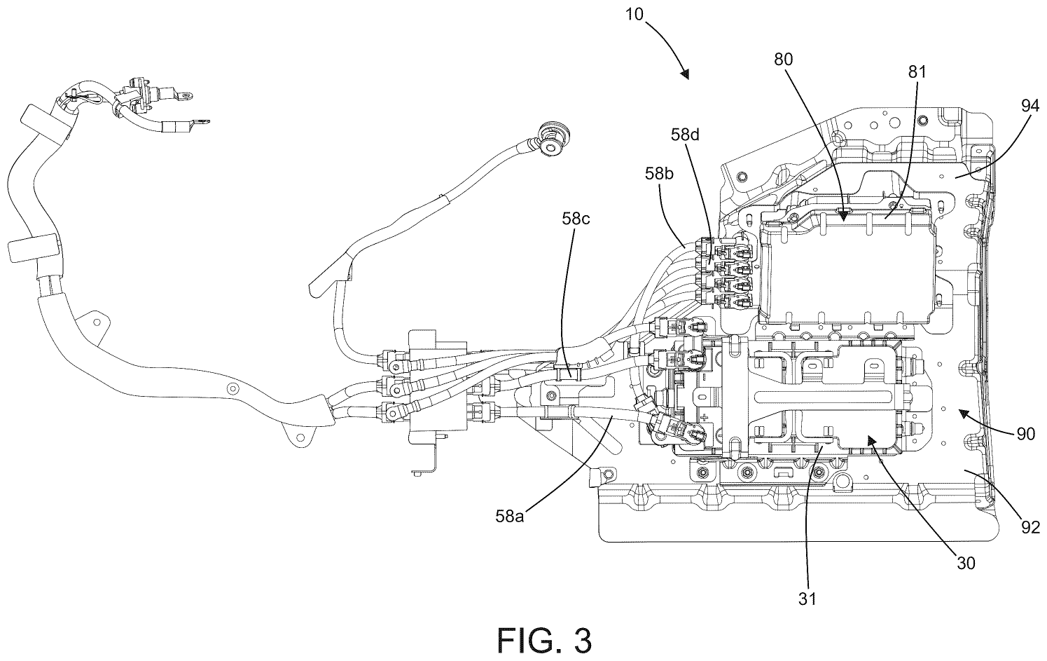

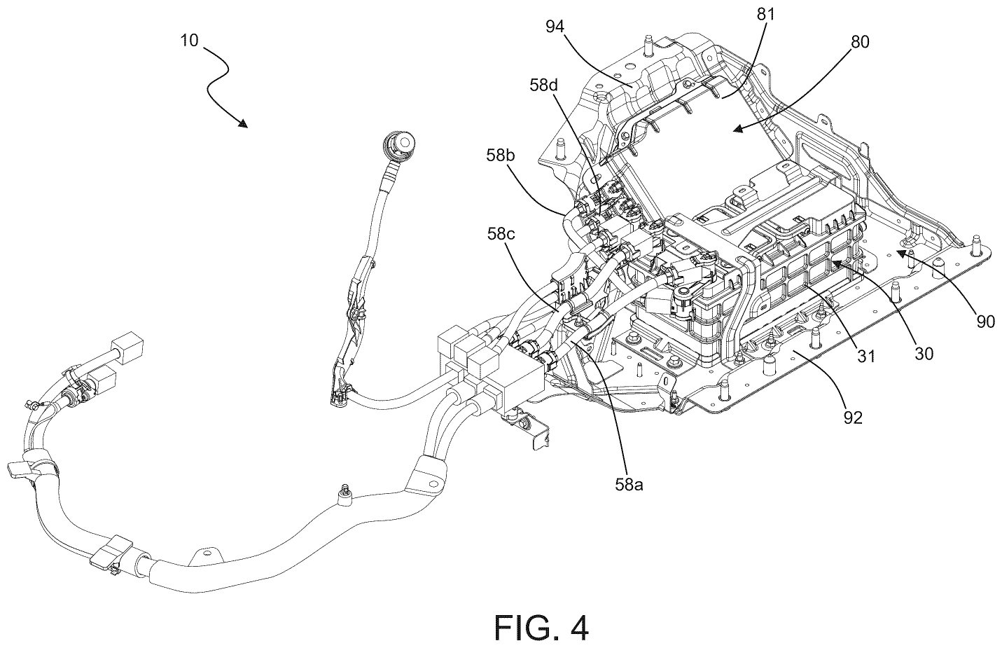

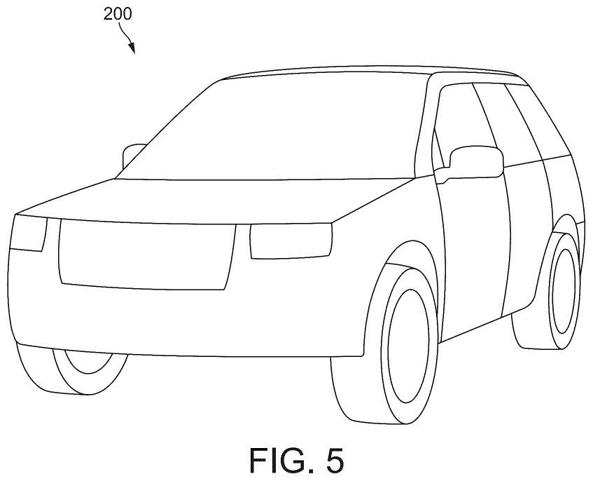

FIGS. 3 and 4 illustrate a part of the overcurrent protection system 10 as may be incorporated into a vehicle 200 (FIG. 5). Like features to those of the schematic shown in FIGS. 1 and 2 will be denoted by like references. It will be appreciated that the overcurrent protection system 10 of FIGS. 3 and 4 is shown absent the inverter 70. Instead, there is shown the first electrical conductor 58a and the third electrical conductor 58c extending from the electrochemical cell 30. The first and third electrical conductors 58a, 58c are each shown with a connector at their free end for connection with the positive terminal 72 and negative terminal 74 of the inverter 70. Furthermore, the electrochemical cell 30 may include a housing 31. The DC-DC converter 80 may also include a housing 81. It will be appreciated that a number of the features described above with respect to FIGS. 1 and 2, e.g. busbars 34, 36, processor 50, controller 52, field effect transistors 54, 56 and/or sensors 46, 47, 49 may be located within one or more of the housings 31, 81 and therefore are not shown in FIGS. 3 and 4.

As shown in FIGS. 3 and 4, each of the electrochemical cell 30 and DC-DC converter 80 may be mounted to a vehicle body panel 90. The vehicle body panel 90 may have a first portion 92 and a second portion 94 inclined with respect to the first portion 92. As is shown in FIGS. 3 and 5, the electrochemical cell 30 may be mounted to the first portion 92 and the DC-DC converter 80 may be mounted to the second portion 94. As such, the electrochemical cell 30 and the DC-DC converter 80 may be inclined with respect to one another.

FIG. 5 illustrates a vehicle 200 according to an embodiment of the present invention. The vehicle 200 is a MHEV in this embodiment and comprises an overcurrent protection system 10 as illustrated in FIGS. 1 to 4.

It will be appreciated that various changes and modifications can be made to the present invention without departing from the scope of the present application.

1. An overcurrent protection system for a vehicle, the overcurrent protection system comprising:
a processor;
one or more sensors operatively connected to the processor; and
an electrochemical cell comprising:
a first electrical terminal and a second electrical terminal having a conductive path defined therebetween; and
a switch having a first state in which a conductive path through the first electrical terminal is uninterrupted, and a second state in which a conductive path through the first electrical terminal is interrupted;
wherein the one or more sensors is or are operatively connected to the first electrical terminal and/or the second electrical terminal of the electrochemical cell for determining a current therethrough; and
wherein the processor is configured to:
receive one or more signals representative of a measured current at the first electrical terminal and/or the second electrical terminal of the electrochemical cell, in use; and
cause the switch to enter the second state in dependence on the measured current.

2. The overcurrent protection system of claim 1, wherein the first electrical terminal is a positive electrical terminal and the second electrical terminal is a negative electrical terminal.

3. The overcurrent protection system of claim 1, wherein the processor is further configured to:
compare the measured current with a predetermined current threshold; and
if it is determined that the measured current is greater than the predetermined current threshold, the switch is caused to enter the second state.

4. The overcurrent protection system of claim 3, wherein the processor is further configured to send a command signal to a controller to instruct the switch to enter the second state if it is determined that the measured current is greater than the predetermined current threshold for a predetermined period of time.

5. The overcurrent protection system of claim 4, wherein the predetermined current threshold is 60 Amps and the predetermined period of time is less than or equal to 10 seconds, for example less than or equal to 2 seconds.

6. The overcurrent protection system of claim 1, wherein the electrochemical cell comprises:
a field effect transistor operatively connected to the first electrical terminal of the electrochemical cell;
a controller operatively connected to the field effect transistor;
wherein the processor is operatively connected to the controller and is configured to send a command signal to the controller to cause an input voltage to be provided to the field effect transistor if it is determined that the switch fails to enter the second state.

7. The overcurrent protection system according to claim 3, comprising an inverter connected to the first electrical terminal and/or second electrical terminal of the electrochemical cell.

8. The overcurrent protection system of claim 7, wherein the one or more sensors are configured to determine the current received from the inverter at the first electrical terminal of the electrochemical cell.

9. The overcurrent protection system of claim 8, wherein the processor is operatively connected to the inverter and is configured to receive one or more signals representative of a current sent from the inverter to the electrochemical cell, wherein the predetermined current threshold is set in dependence on the current sent from the inverter to the electrochemical cell.

10. The overcurrent protection system of claim 3, comprising a DC-DC converter connected to the first electrical terminal and/or second electrical terminal of the electrochemical cell.

11. The overcurrent protection system of claim 10, wherein the one or more sensors are configured to determine the current drawn by the DC-DC converter at the first electrical terminal of the electrochemical cell.

12. The overcurrent protection system of claim 11, wherein the processor is operatively connected to the DC-DC converter and is configured to receive one or more signals representative of a current drawn from the electrochemical cell by the DC-DC converter, wherein the predetermined current threshold is set in dependence on the current drawn from the electrochemical cell by the DC-DC converter.

13. The overcurrent protection system of claim 10, wherein the DC-DC converter comprises:
a field effect transistor operatively connected to an input of the DC-DC converter;
a controller operatively connected to the field effect transistor;
wherein the processor is operatively connected to the controller and is configured to send a command signal to the controller to cause an input voltage to be provided to the field effect transistor if it is determined that the switch fails to enter the second state.

14. The overcurrent protection system of claim 1, wherein the switch comprises a solid state switch.

15. The overcurrent protection system of claim 1, wherein the processor is configured to receive one or more signals representative of a measured current at the first electrical terminal and/or the second electrical terminal of the electrochemical cell when the switch is in the first state.

16. The overcurrent protection system of claim 1, wherein the electrochemical cell has an electrical potential of 48 volts.

17. The overcurrent protection system of claim 1, comprising:
an electrical conductor electrically connected to the first electrical terminal and/or the second electrical terminal of the electrochemical cell;
wherein the one or more sensors is or are operatively connected to the electrical conductor for determining a current passing therealong;
wherein the processor is configured to:
receive one or more signals representative of measured current passing along the electrical conductor, in use;
cause the switch to enter the second state in dependence on the measured current.

18. The overcurrent protection system of claim 17, comprising:
a respective electrical conductor electrically connected to the first electrical terminal and the second electrical terminal of the electrochemical cell;
wherein the one or more sensors is or are operatively connected to each electrical conductor for determining a current passing therealong;
wherein the processor is configured to:
receive one or more signals representative of measured current passing along each electrical conductor, in use;
cause the switch to enter the second state in dependence on the measured current.

19. An overcurrent protection system for a vehicle, the overcurrent protection system comprising:
a power electronics module comprising:
an electrochemical cell having a first electrical terminal and a second electrical terminal;
an inverter electrically connected to the first electrical terminal of the electrochemical cell;
a DC-DC converter electrically connected to the first electrical terminal of the electrochemical cell:
wherein the electrochemical cell further comprises a switch having a first state in which a conductive path through the first electrical terminal is uninterrupted and electrical communication is provided between the inverter and the DC-DC converter, and second state in which a conductive path through the first electrical terminal is interrupted and no electrical communication is provided between the inverter and the DC-DC converter;
the overcurrent protection system further comprising:
a processor;
one or more sensors operatively connected to the processor;
wherein the processor is configured to:
receive one or more signals representative of a measured current at the first electrical terminal and/or the second electrical terminal of the electrochemical cell, in use cause switch to enter the second state in dependence on the measured current.

20. The overcurrent protection system according to claim 19, wherein the power electronics module is devoid of an external fuse.
